(19) United States
(12) Patent Application Publication
(10) Pub. No.: US 2009/0024440 A1
(43) Pub. Date: Jan. 22, 2009

(54) Automated Workflow Via Learning for Image Processing, Documentation and Procedural Support Tasks

(75) Inventor: Martin Spahn, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/024,428

(22) Filed: Feb. 1, 2008

Related U.S. Application Data
(60) Provisional application No. 60/950,424, filed on Jul. 18, 2007.

(51) Int. Cl. G06Q 50/00; G06Q 10/00

(52) U.S. Cl. 705/9; 705/2; 705/7

(57) ABSTRACT

A method to manage workflow tasks having the steps of conducting at least one procedure, wherein the at least one procedure has at least one workflow task, recording each workflow task completed in the at least one procedure in a database, analyzing each workflow task completed, wherein the analysis completed identifies each task that may be completed automatically without need for human intervention, define workflow tasks for a given procedure that are to be completed automatically, inputting a user defined procedure, retrieving workflow tasks pertaining to the user defined procedure that are automatically performed, and conducting the user defined procedure, wherein workflow tasks defined as automatic are automatically performed.

### CROSS-REFERENCE TO RELATED APPLICATIONS

The present invention claims priority to U.S. Provisional Application 60/950,424, filed Jul. 18, 2007, the entirety of which is incorporated by reference.

### FIELD

The present invention relates to image processing. More specifically, the present invention relates to an apparatus and method to produce an automated workflow via learning for image processing, documentation and procedural support tasks.

### BACKGROUND INFORMATION

Today, diagnostic and interventional x-ray procedures in radiology require considerable manual postprocessing involvement. The procedure of postprocessing is needed to improve image quality. Such postprocessing functions can include modifying image contrast, sharpness and/or improving match or mask and actual image in a digital subtraction angiography procedure. Other postprocessing procedures include reviewing individual image sequences and selecting individual images from that sequence to be sent to a picture archiving system. Furthermore, physical measures such as burning a compact disc may be performed by individuals as well as a selection and display of a reference image used during and interventional procedure such as an angioplasty. Today, such procedures are done by laboratory technicians manually and require a substantial share of the working lab technicians.

There is a need, therefore to provide a method and apparatus to automate individual functions normally conducted during or after medical procedures.

There is a further need to automatically conduct post image processing functions to increase the economic efficiency of such functions.

There is also a need to automatically conduct post image processing functions and have the functions be applicable and/or adaptable to existing technological systems, such as Picture Archiving systems (PACs) systems.

### SUMMARY

It is therefore an objective of an aspect of the invention to provide a method to automate individual functions normally conducted during or after radiological procedures.

It is a further objective of an aspect of the present invention to provide for automatically conducting post image processing functions to increase the economic efficiency of such functions.

It is a still further objective of an aspect of the present invention to provide for automatically conducting post image processing functions and have the functions be applicable and/or adaptable to existing technological systems, such as Picture Archiving systems (PACs) systems.

The objectives are achieved as illustrated and described. A method to manage workflow tasks is presented, comprising the steps of conducting at least one procedure, wherein the at least one procedure has at least one workflow task, recording each workflow task completed in the at least one procedure in a database, analyzing each workflow task completed, wherein the analysis completed identifies each task that may be completed automatically without need for human intervention, defining workflow tasks for a given procedure that are to be completed automatically, inputting a user defined procedure, retrieving workflow tasks pertaining to the user defined procedure that are automatically performed, and conducting the user defined procedure, wherein workflow tasks defined as automatic are automatically performed.

In an alternative exemplary embodiment, the at least one procedure is a medical procedure. The medical procedure may be an x-ray. The automatically performed workflow task may be one of dimming a lights in an evaluation room, positioning a C-arm for an evaluative instrument and positioning a patient table to a prerecorded position.

In an alternative exemplary embodiment, the method may be accomplished such that the automatically performed workflow task is one of post processing images to improve image quality, burning a compact disk with images from the medical procedure and displaying a reference image on a picture archiving system.

In another exemplary alternative of the invention, the method may be accomplished such that the automatically performed workflow task is one of post processing images obtained for adjusting image contrast, adjusting image sharpness and matching of masked images.

In another exemplary alternative of the invention, the method may be accomplished such that the images are conducted during a digital subtraction angiography procedure.

In another exemplary embodiment of the invention, the method may be accomplished to include a conducting of a user defined procedure, wherein workflow tasks defined as automatic are automatically performed.

In another exemplary embodiment of the invention, the method may be performed to further comprise conducting the user defined procedure, wherein the workflow tasks defined as automatic are automatically performed only by a user acknowledging acceptance of accomplishing the tasks.

In another exemplary embodiment of the invention, the method may be performed to further comprise completing a patient data sheet to prior to the inputting of the user defined procedure, wherein the patient data sheet dictates the user defined procedure.

In an alternative exemplary embodiment, the method may be accomplished such that the medical procedure is one of a computer tomography, a magnetic resonance imaging and an ultrasound imaging, PET or SPECT imaging or combined or merged images from various modalities.

In an alternative exemplary embodiment of the invention, a program storage device readable by machine, tangibly embodying a program of instructions executable by the machine to perform method steps to manage workflow tasks is provided wherein the method comprises the steps of conducting at least one procedure, wherein the at least one procedure has at least one workflow task, recording each workflow task completed in the at least one procedure in a database, analyzing each workflow task completed, wherein the analysis completed identifies each task that may be completed automatically without need for human intervention, define workflow tasks for a given procedure that are to be completed automatically, inputting a user defined procedure, retrieving workflow tasks pertaining to the user defined procedure that are automatically performed, and conducting the user defined procedure, wherein workflow tasks defined as automatic are automatically performed.

The program storage device may also be configured, wherein the method accomplished there provides for the least one procedure to be a medical procedure. The medical procedure may be an x-ray.

In an alternative exemplary embodiment, the program storage device may perform a method, wherein an automatically performed workflow task is one of dimming a lights in an evaluation room, positioning a C-arm for an evaluative instrument and positioning a patient table to a prerecorded position.

In another exemplary embodiment of the invention, the program storage device may perform the method, wherein the automatically performed workflow task is one of post processing images to improve image quality, burning a compact disk with images from the medical procedure and displaying a reference image on a picture archiving system.

In another exemplary embodiment of the invention, the program storage device may be configured such that the method further comprises completing a patient data sheet to prior to the inputting of the user defined procedure, wherein the patient data sheet dictates the user defined procedure.

In another exemplary embodiment, a method to manage workflow tasks is provided. The method comprises the steps of conducting at least one procedure, wherein the at least one procedure has at least one workflow task; recording each workflow task completed in the at least one procedure in a database, analyzing each workflow task completed, wherein the analysis completed identifies each task that may be completed automatically without need for human intervention, defining workflow tasks for a given procedure that are to be completed automatically, inputting a user defined procedure; retrieving workflow tasks pertaining to the user defined procedure that are automatically performed, and conducting the user defined procedure, wherein workflow tasks defined as automatic are semi-automatically performed.

### BRIEF DESCRIPTION OF THE DRAWINGS

FIG. 1 is a flowchart describing the learning phase and execution phase of an automated workflow support system.

FIG. 2 is a diagnostic and interventional x-ray system for cardiac, neurological or general angiography procedures.

FIG. 3 is a flow chart for a method to produce an automated workflow via learning for image processing, documentation and procedural support tasks.

### DETAILED DESCRIPTION

An embodiment of the present invention provides a method and system that uses learning to automate documentation tasks useful in medical examinations. The method accepts data obtained during medical evaluations and analyzes the data to determine which steps or processes in the procedure can be performed in an automatic or semi-automatic way.

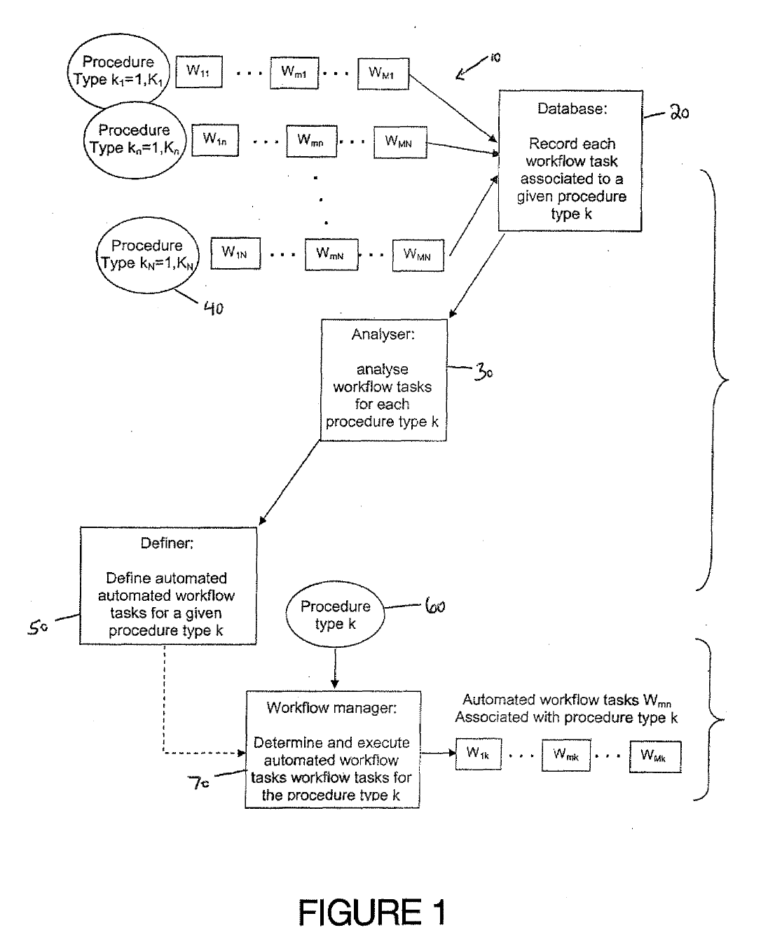

Referring to FIG. 1, a system for an embodiment of the present invention provides for a method to produce an automated workflow via learning for image processing, documentation and procedural support tasks 10. As provided herein, workflow tasks are steps of medical procedures that may be completed by a medical professional. Such medical procedures may be, as non-limiting examples, x-rays, computed tomography scans and ultrasound examinations. Each of the individual workflow tasks is provided with an identifier W_{MN} where M and N are integers.

The database 20 is provided such that it records each workflow task associated to a given procedure type k. The information obtained in the database is then analyzed in an analyzer 30. The analyzer analyzes workflow tasks for each procedure type k 40. Next, workflow tasks that may be automated are determined for each procedure type k 50. Input may be provided during the definition of which workflow tasks may be automated 50 such that tasks which may be performed automatically are identified as well as those requiring human manipulation. Such input may take into account such features as the capability of machines to perform task manually and the need for medical personnel to evaluate a given set of conditions.

Next, when a given procedure is selected, such as by a medical professional 60, the procedure is entered into a workflow manager 70. Based upon the procedure type K that is to be performed, the workflow manager 70 then obtains information from the defining section 50 and enables the automatic features for completion of desired tasks W₁ₖ through W_{Mk}.

The learning phase of the system is dictated by the number or amount of informational sources available to the system. In exemplary embodiment of the invention provided the learning phase may take as little as one week or as much as one month, depending on the number of patients done for a typical procedure. In an exemplary embodiment, an average of 20 to 50 procedures is recommended to use during the learning phase. This depends on the spread of applications such as diagnostic or interventional cardiac angiograph the imaging only, or general or neurological a geography procedures only, or combinations thereof, i.e. the number of procedural types.

During a learning phase of the system, each workflow task for a given procedure is recorded in the database 20. This data is then analyzed during the learning phase. A definition module determines which workflow tasks are typically associated with which procedure type by correlating its current “knowledge” with new procedures and associated workflow steps being performed manually.

Once the system is ready for automated or semi-automated workflow support, the system proposes workflow tasks to be okayed via a mouse click or voice command by the user or severally performs workflow tasks without the need of an “OK” by the user for a given procedure. The procedure type is known from the patient data sheet filled before the procedure or via a hospital information system/radiological information system whose information is downloaded to the x-ray system.

After the learning phase (during the automated phase) the image processing and display unit of the x-ray system would automatically suggest certain workflow steps such as pixel shift, contrast enhancement, compact disc burning, et cetera. The automatic system support can be implemented in two ways.

The system can be implemented in a semi-automatic support mode where the system would suggest a certain postprocessing or documentation step such as change contrast, automatically perform pixel shift, proposal of certain images from a series to be documented, and a mouse click or similar would be required perform that task.

The system may also be implemented in a fully automatic mode. In this mode, the system would suggest and automatically perform a certain postprocessing or documentation step without manual interference or acceptance such as by a mouse click.

Workflow tasks can be extended beyond image processing or image storage tasks to mechanical tasks such as the system moving the C arm automatically to the right position before the procedure starts, turning lights off, changing image quality whenever an x-ray activation system is used or moving collimators or wedges into the x-ray beam to improve imaging and/or help to reduce unnecessary x-ray exposure.

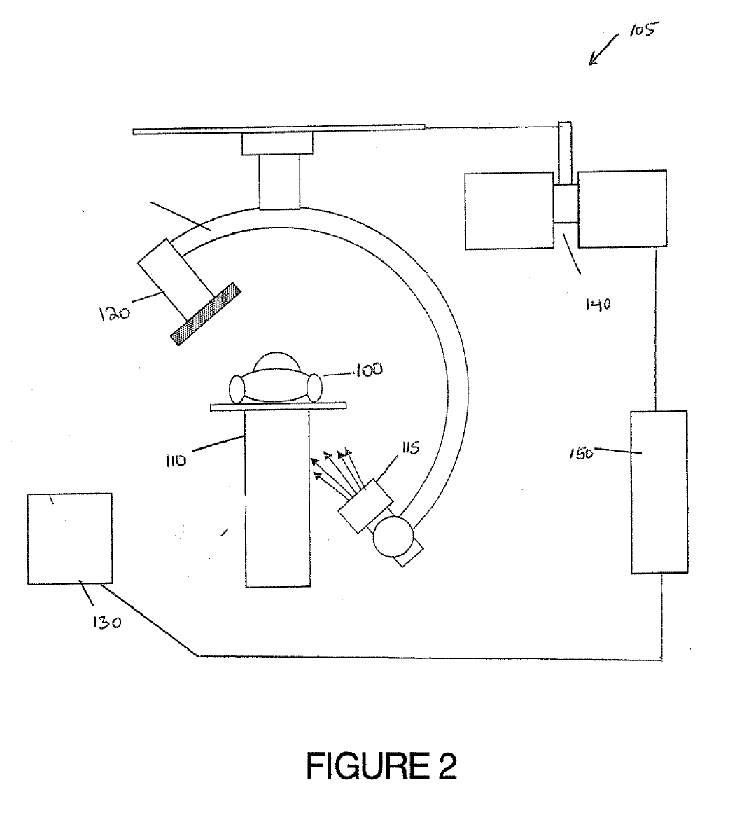

Referring to FIG. 2, a diagnostic and interventional x-ray system 105 for cardiac, neurological or general angiography is presented. A patient 100 is located on a patient table 110 that may be mechanized. In an embodiment of the present invention, the patient 100 is to undergo an x-ray evaluation. A C-arm with x-ray 115 and detector 120 is positioned through machinery to the area of the body of the patient requiring evaluation. Images obtained from the detector 120 are transferred to a system control and imaging system 130. The images obtained are displayed on an image display system 140. A generator 150 provides power to the overall system 105.

Through use of the method of an exemplary invention, different features of the diagnostic and interventional x-ray system for cardiac, neurological or general angiography may be automated. As non-limiting examples, the C-arm, as illustrated in FIG. 2, may be automatically moved to the optimum position for evaluation, in the illustrated embodiment, a lower side position.

The analyzer module in the imaging system 130 can be based on an expert system or an artificial neural network or similar intelligent systems with learning capabilities.

Workflow support system can be extended to other than x-ray diagnostic or interventional tasks such as computer tomography, magnetic resonance imaging, ultrasound imaging etc.

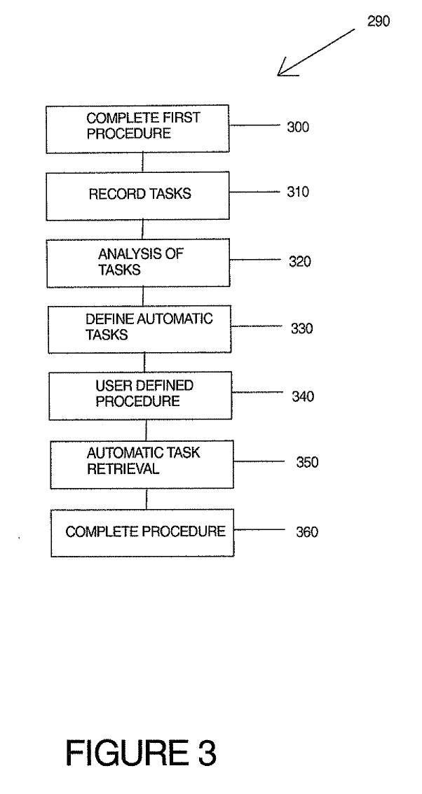

Referring to FIG. 3, a method 290 for managing workflow tasks is presented. First, at least one procedure is completed, wherein the at least one procedure has at least one workflow task 300. The procedure can be any type of medical procedure performed. In the present non-limiting exemplary embodiment, the procedure is an x-ray scan. Next, each work flow task (i.e. the individual steps need to perform the procedure) is recorded that is completed 310. Recording may take place in the database 20. Next, an analysis of each workflow task completed is performed 320, wherein the analysis completed identifies each task that may be completed automatically without need for human intervention. Next, workflow tasks are defined for a given procedure that are to be completed automatically 330. A user may then input a user defined procedure 340. Next, workflow tasks are retrieved pertaining to the user defined procedure that are automatically performed 350. Next, the user defined procedure is conducted wherein workflow tasks defined as automatic are automatically performed 360. Other steps may be added or the order of the steps altered, as needed.

Embodiments of the present invention provide a method to automate individual functions normally conducted after radiological procedures.

Embodiments of the present invention provide for automatically conducting post image processing functions to increase the economic efficiency of such functions.

Embodiments of the present invention also provide for automatically conducting post image processing functions and the functions are applicable and/or adaptable to existing technological systems, such as Picture Archiving systems (PACs) systems.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method to manage workflow tasks, comprising:
conducting at least one procedure, wherein the at least one procedure has at least one workflow task;
recording each workflow task completed in the at least one procedure in a database;
analyzing each workflow task completed, wherein the analysis completed identifies each task that may be completed automatically without need for human intervention;
defining workflow tasks for a given procedure that are to be completed automatically;
inputting a user defined procedure;
retrieving workflow tasks pertaining to the user defined procedure that are automatically performed; and
conducting the user defined procedure, wherein workflow tasks defined as automatic are automatically performed.

2. The method according to claim 1, wherein the at least one procedure is a medical procedure.

3. The method according to claim 2, wherein the medical procedure is an x-ray.

4. The method according to claim 2, wherein an automatically performed workflow task is at least one of dimming lights in an evaluation room, positioning a C-arm for an evaluative instrument and positioning a patient table to a prerecorded position.

5. The method according to claim 2, wherein the automatically performed workflow task is at least one of post processing images to improve image quality, burning a compact disk with images from the medical procedure and displaying a reference image on a picture archiving system.

6. The method according to claim 2, wherein the automatically performed workflow task is at least one of post processing images obtained for adjusting image contrast, adjusting image sharpness and matching of masked images.

7. The method according to claim 6, wherein the images are conducted during a digital subtraction angiography procedure.

8. The method according to claim 1, wherein conducting the user defined procedure, wherein workflow tasks defined as automatic are automatically performed.

9. The method according to claim 1, wherein the conducting of the user defined procedure entails automatically performing the defined workflow tasks defined only by a user acknowledging acceptance of accomplishing the tasks.

10. The method according to claim 2, wherein the medical procedure is one of a computer tomography, a magnetic resonance imaging and an ultrasound imaging.

11. A program storage device readable by machine, tangibly embodying a program of instructions executable by the machine to perform method steps to manage workflow tasks, comprising:
conducting at least one procedure, wherein the at least one procedure has at least one workflow task;
recording each workflow task completed in the at least one procedure in a database;
analyzing each workflow task completed, wherein the analysis completed identifies each task that may be completed automatically without need for human intervention;
define workflow tasks for a given procedure that are to be completed automatically;
inputting a user defined procedure;
retrieving workflow tasks pertaining to the user defined procedure that are automatically performed; and
conducting the user defined procedure, wherein workflow tasks defined as automatic are automatically performed.

12. The program storage device according to claim 11, wherein the at least one procedure is a medical procedure.

13. The program storage device according to claim 12, wherein the medical procedure is an x ray.

14. The program storage device according to claim 12, wherein an automatically performed workflow task is one of dimming a lights in an evaluation room, positioning a C-arm for an evaluative instrument and positioning a patient table to a prerecorded position.

15. The program storage device according to claim 12, wherein the automatically performed workflow task is one of post processing images to improve image quality, burning a compact disk with images from the medical procedure and displaying a reference image on a picture archiving system.

16. The program storage device according to claim 11, wherein the method steps further comprise:
completing a patient data sheet to prior to the inputting of the user defined procedure, wherein the patient data sheet dictates the user defined procedure.

17. A method to manage workflow tasks, comprising:
conducting at least one procedure, wherein the at least one procedure has at least one workflow task;
recording each workflow task completed in the at least one procedure in a database;
analyzing each workflow task completed, wherein the analysis completed identifies each task that may be completed automatically without need for human intervention;
defining workflow tasks for a given procedure that are to be completed automatically;
inputting a user defined procedure;
retrieving workflow tasks pertaining to the user defined procedure that are automatically performed; and
conducting the user defined procedure, wherein workflow tasks defined as automatic are semi-automatically performed.
